(19) United States
(12) Patent Application Publication
(10) Pub. No.: US 2018/0055273 A1
(43) Pub. Date: Mar. 1, 2018

(54) TEAPOT

(71) Applicant: David Richard BIRCH, London (GB)

(72) Inventor: David Richard BIRCH, London (GB)

(21) Appl. No.: 15/686,414

(22) Filed: Aug. 25, 2017

(30) Foreign Application Priority Data
Aug. 26, 2016 (GB) 1614539.3
Aug. 15, 2017 (GB) 1712768.9

(51) Int. Cl. A47J 31/06

(52) U.S. Cl. CPC A47J 31/0636; A47G 19/14

(57) ABSTRACT

A teapot is disclosed. It comprises a body having an aperture, a lip extending about the aperture, a filter element positionable so as to extend into the body through the aperture whilst being supported by the lip, and a lid to close the aperture over the filter element. The teapot also comprises a dish in which to stand the filter element upon removal of the filter element from the body. The dish is stowable, when not in use, within the filter element so that the lid extends over both the filter element and the dish.

### CROSS-REFERENCE TO RELATED APPLICATIONS

The present application claims the benefit of and priority to GB Patent Application Serial No. 1712768.9, filed on Aug. 15, 2017, which claims the benefit of and priority to GB Patent Application Serial No. 1614539.3, filed on Aug. 26, 2016, the entire content of each of which being incorporated herein by reference.

### BACKGROUND

This present disclosure relates to a teapot having a tea filter.

The problem with brewing fresh tea with tea leaves as opposed to the current fashion either of having instant tea or using tea bags is to ensure that the tea is in adequate contact with the brewing water while preventing the tea leaves from leaving the brewing vessel, normally a tea pot, while the tea is being poured out. One means of achieving this is to provide a tea filter separate from the teapot and through which the tea is poured so that any tea leaves will remain in the tea filter and cannot be poured out of the teapot into the recipients cup. In addition to this is the practical problem of overcoming the length of time a tea loaded filter remains within in the hot liquid in teapot for the tea to remain fresh and avoid stewing.

### SUMMARY

The present disclosure seeks to provide an improved teapot.

According to the disclosure, there is provided a teapot comprising a body having an aperture, a lip extending about the aperture, a filter element positionable so as to extend into the body through the aperture whilst being supported by the lip, a lid to close the aperture over the filter element, and a dish in which to stand the filter element upon removal of the filter element from the body, wherein the dish is stowable, when not in use, within the filter element so that the lid extends over both the filter element and the dish.

The dish is received in the filter element and is concealed beneath the closed lid of the teapot when not in use. However, when the lid is opened, the dish can be removed and the filter element stood in the dish to collect any residual tea that drains from the filter element.

Preferably, the filter element has an open upper end and the dish nests within the open upper end of the filter element.

The filter element may comprise a flange that rests on the lip, and the dish may comprise a rim that that rests on the flange of the filter element when the dish is nested within the filter element.

The filter element preferably narrows in a direction away from the flange towards a base configured to enable the filter element to be stood on its base within the dish when the filter element and the dish are removed from the teapot and the dish is removed from the filter element.

In a preferred embodiment, a tab extends laterally from the flange of the filter element and the rim of the dish to facilitate lifting of the filter element and the dish, respectively, out of the body.

The tab on the filter element and the tab on the dish are preferably configured so that the tab on the dish overlaps the tab on the filter element when the dish is received in the filter element.

The tab of the dish may have a portion that does not overlap the tab of the filter element to enable the dish to be lifted out of the filter element using the tab of the dish. Most preferably, the tab of the dish has a bent portion that extends away from the tab of the filter element.

The lid may be supported, in its closed position, on the flange of the filter element and the rim of the dish, when closed.

Preferably, an upper rib protrudes from the lip to surround, and extend beyond, the closed lid.

In a preferred embodiment, there is a gap in the upper rib to receive the tab of the filter element and the tab of the dish.

Preferably, the tab of the filter element and the tab of the dish protrude beyond an outer periphery of the lid.

The body comprises a bottom wall and, preferably, a lower rib protruding from the bottom wall on which the body is supported when stood on a surface, the lower rib being shaped such that, when placed on top of another teapot, the lower rib surrounds the upper rib of said another teapot.

Preferably, there is a gap in said lower rib to receive the tab of the filter element and the tab of the dish protruding from said another teapot.

The lid may be pivotally mounted to the body for movement between open and closed positions.

The filter element and the dish may be shaped to prevent relative movement when the dish is received in the filter element. For example, the filter element and dish may be oval shaped.

### DESCRIPTION OF DRAWINGS

The teapot according to the present disclosure will now be described in greater detail, by way of example only, with reference to the accompanying drawings in which:

FIG. 1 is a partial vertical cross section through a teapot showing the drip tray and tea filter in accordance with an embodiment of the disclosure;

FIG. 2A is a view of the teapot as shown in FIG. 1, with the hinged lid open and the drip tray and tea filter removed

FIG. 2B is a view of the tea filter stood in the drip tray

FIG. 3 is a perspective view of the teapot with its lid open, the filter element received in the body and the drip tray received in the filter element;

FIG. 4A is a view showing the teapot, drip tray and filter element separately.

FIG. 4B is a perspective view of the filter element stood in the drip tray

FIG. 5A is a first view showing one teapot stacked on top of another teapot; and

FIG. 5B is the view of FIG. 5A from a different angle.

### DETAILED DESCRIPTION

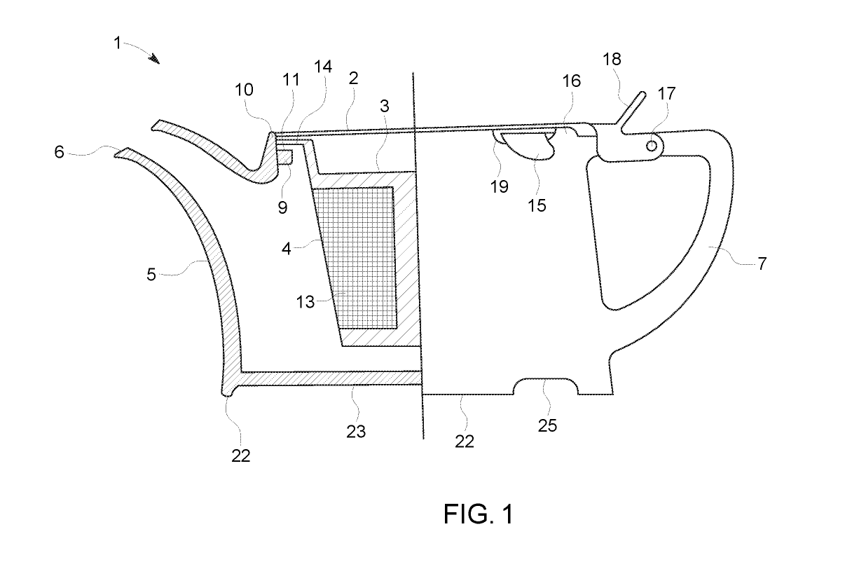

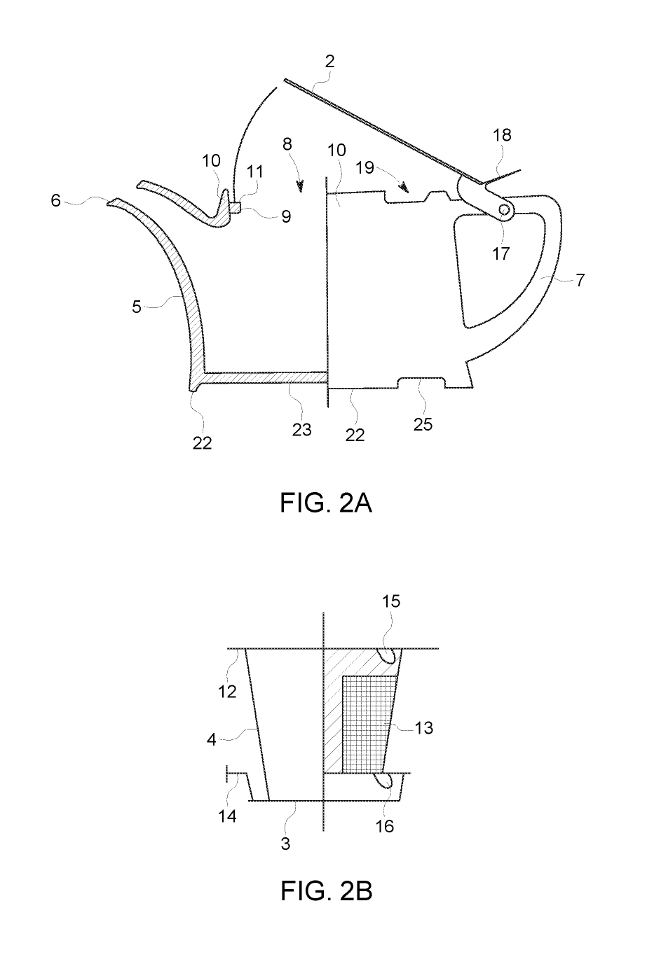

FIG. 1 shows a teapot 1 with a teapot lid 2, a dish or drip tray 3 and a perforated tea filter or filter element 4. The teapot 1 is of an oval design, although rounded or another shape is also envisaged. It comprises a receptacle or body 5 having a pouring spout 6 to one end and a handle 7 on the opposite side. At the top of the teapot 1 is a water filling aperture 8 having an inwardly extending lip 9 surrounded by a peripheral rib 10 so that the lip 9 is recessed in relation to the rib 10 so that it provides a seat 11 for a purpose to be described.

The removable tea filter 4 is located within the teapot 1. The tea filter 4 is received within the receptacle 5 and is provided with a flange 12 which is arranged to sit on the seat 11 of the lip 9 of the water filling aperture 8 to prevent the tea filter 4 from passing completely into the receptacle 7 of the tea pot 1. The filter 4 is formed with a number of perforated areas or panels 13. Tea leaves or tea bags may be placed in the tea filter 4 so that they are submerged in water contained within the teapot 1 to brew tea.

When not in use, the drip tray 3 sits or nests within the top of the filter 4, as shown in FIG. 1. The drip tray 3 has a rim 14 which sits on top of the flange 12 of the filter 4. Both the filter 4 and the drip tray 3 have tabs 15, 16 to effect their ease of removal from the teapot 1 following sufficient brewing time. The tab 15 on the tea filter extends laterally from the flange 12, and the tab 16 on the drip tray 3 extends laterally from the rim 14.

When the tea has brewed sufficiently, the lid 2 of the teapot 1 is opened. The tea filter 4 is then removed from the teapot 1 and the drip tray 3 removed from the tea filter 4. The drip tray 3 is then placed on a surface, such as a table or countertop, and the filter element 4 is then stood in the shallow drip tray 3.

The lid 2 sits, when closed, within the annular lip 9 to cover both the drip tray 3 and beneath it the filter 4. The lid 2 is activated by way of a riveted hinge 17 and is raised by way of a thumb tab 18, which when pressed raises the lid 2.

In use, the lid 2 is first opened giving access to the water filling aperture 8 in which sits the drip tray 3 and underneath that the filter 4. The drip tray 3 is then removed by placing a finger under the drip tray tab 16. Tea is then added to the open filter 4. Boiling water is then added to commence the brewing process which takes place through the filters perforations 13.

After a predetermined length of time to allow the tea for brewing, the spent tea filled filter 4 is removed by way of the downwardly sloping tab 15 which, when not in use, sits directly below the straight removal tab 16 of the drip tray. With removal of the tea saturated filter 4, this is then placed within the matching drip tray 4 to cool & drain.

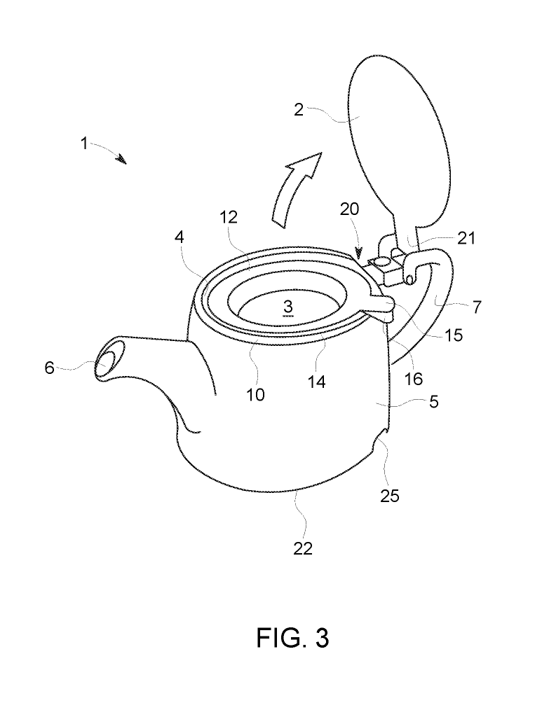

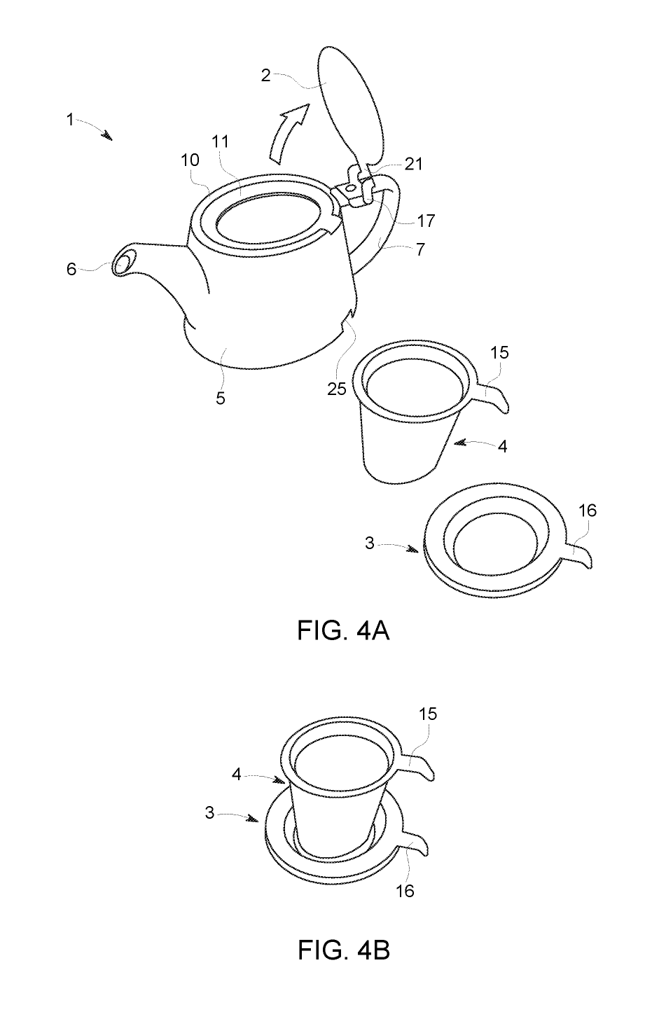

FIG. 3 shows the teapot 1 with its lid 2 open and the tea filter 4 and drip tray 3 received within it. The component parts are shown disassembled in FIG. 4. It will be appreciated that the filter 4 sits in contact with the seat 11 of the inner gallery/lip 9 which is surrounded by the retaining wall or rib 10.

A break 19 in the retaining wall or rib 10 allows for flat access to the lip 9 thereby providing a position for the elongated protruding filter tab 15 and the downward protruding tab 16 of the drip tray 3 to locate.

A further gap 20 in the rib 10 may be provided at the rear of the teapot opening 8 to allow for the lid 2 hinge attachment 21 to lie flat in the closed position.

To allow for greater potential volume use within the catering trade the teapot 1 has been designed in such a way as to allow for stacking and thereby saving space in a confined environment. The lid 2 locates within a recess formed by the rib 10 with the straight protruding drip tray tab 16 sitting on top of the filter 4 protruding downwardly over the sloping filter tab 15.

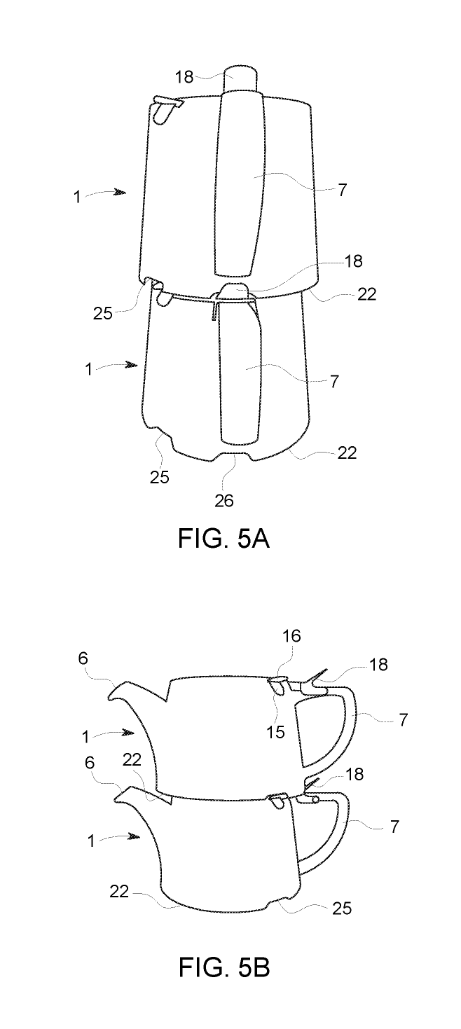

The teapot 1 has a lower rib 22 or foot ring which spaces the bottom wall 23 of the teapot 1 away from a surface on which the teapot 1 is placed. The lower rib 22 has a break 25 positioned so that, when the teapot 1 is stacked on top of another teapot, as shown in FIGS. 5A and 5B, the tab 15 of the tea filter 4 and the drip tray 3 locate in the break 25 in the lower rib 23 of the teapot 1 directly above it. A similar break 26 (see FIG. 5A) may be provided in the lower rib 22 to receive the lid tab 21 of the lower teapot 1.

It will be appreciated that various modifications of or additions to can be made to the described embodiment without departing from the scope of the disclosure. For example the shape of the receptacle 5 and the spout 6 and handle 7 can be varied as desired. The water filling aperture 8 can be of other shapes than oval for example round or polygonal. The shape of the filter 4 will also depend on the shape of the water filling aperture 8 so that the filter 4 is a loose fit in the teapot 1 and rests easily on the lip 9. The filter 3 could be made of different materials such as plastics material or a combination of different materials.

1. A teapot comprising:
a body having an aperture,
a lip extending about the aperture,
a filter element positionable so as to extend into the body through the aperture whilst being supported by the lip,
a lid to close the aperture over the filter element, and
a dish in which to stand the filter element upon removal of the filter element from the body, wherein the dish is stowable, when not in use, within the filter element so that the lid extends over both the filter element and the dish.

2. A teapot according to claim 1, wherein the filter element has an open upper end and the dish nests within the open upper end of the filter element.

3. A teapot according to claim 2, wherein the filter element comprises a flange that rests on the lip, and the dish comprises a rim that that rests on the flange of the filter element when the dish is nested within the filter element.

4. A teapot according to claim 3, wherein the filter element narrows in a direction away from the flange towards a base configured to enable the filter element to be stood on its base within the dish when the filter element and the dish are removed from the teapot and the dish is removed from the filter element.

5. A teapot according to claim 4, wherein a tab extends laterally from the flange of the filter element and the rim of the dish to facilitate lifting of the filter element and the dish, respectively, out of the body.

6. A teapot according to claim 5, wherein the tab on the filter element and the tab on the dish are configured so that the tab on the dish overlaps the tab on the filter element when the dish is received in the filter element.

7. A teapot according to claim 6, wherein the tab of the dish has a portion that does not overlap the tab of the filter element to enable the dish to be lifted out of the filter element using the tab of the dish.

8. A teapot according to claim 7, wherein the tab of the dish has a bent portion that extends away from the tab of the filter element.

9. A teapot according to claim 5, wherein the lid is supported on the flange of the filter element and the rim of the dish when closed.

10. A teapot according to claim 9, wherein an upper rib protrudes from the lip to surround, and extend beyond, the closed lid.

11. A teapot according to claim 10, comprising a gap in the upper rib to receive the tab of the filter element and the tab of the dish.

12. A teapot according to claim 11, wherein the tab of the filter element and the tab of the dish protrude beyond an outer periphery of the lid.

13. A teapot according to claim 11, wherein the body comprises a bottom wall and a lower rib protruding from the bottom on which the body is supported when stood on a surface, the lower rib being shaped such that, when placed on top of another teapot, the lower rib surrounds the upper rib of said another teapot.

14. A teapot according to claim 13, comprising a gap in said lower rib to receive the tab of the filter element and the tab of the dish protruding from said another teapot.
